(19) United States
(12) Patent Application Publication
(10) Pub. No.: US 2025/0271024 A1
(43) Pub. Date: Aug. 28, 2025

(54) LATCH DEVICE

(71) Applicant: FOSITEK CORPORATION, NEW TAIPEI CITY (TW)

(72) Inventors: CHUN HAN LIN, NEW TAIPEI CITY (TW); CHE WEI CHANG, NEW TAIPEI CITY (TW); JIA WEI PAN, NEW TAIPEI CITY (TW)

(21) Appl. No.: 18/585,254

(22) Filed: Feb. 23, 2024

(51) Int. Cl. F16C 11/10; E05C 19/00

(52) U.S. Cl. CPC F16C 11/10; E05C 19/008; F16C 2226/62

(57) ABSTRACT

A latch device includes a shell having an actuating lever, a linking member and a sliding member mounted thereto. The actuating lever has a free end formed into two cantilever arms with an open area defined therebetween for mounting a handling member and an elastic element; and a pivotal end pivotally connected to the shell, allowing the actuating lever to move, rotate or swing in a reciprocating motion. The linking member has a first end pivotally connected to a middle area of the actuating lever; and a second end assembled to the shell. When the handling member is pulled or pushed, the actuating lever is movable between a closed and an opened position allowing the linking member and the sliding member to move at the same time. The latch device with the above structure has relatively large open angle and long handling area to facilitate smooth or convenient operation thereof.

### FIELD OF THE INVENTION

The present invention relates to a latch device with improved structure, and more particularly, to a latch device, which has a handling member and an elastic element provided on an actuating lever and a linking member pivotally connected to between a shell and a middle area of the actuating lever, allowing the latch device to operate more smoothly or conveniently than a prior art latch device.

### BACKGROUND OF THE INVENTION

It is a well known skill by mounting a latch device or other similar device to the cover of a computer, electronic device, or server chassis. An operator may turn on or off the computer and the electronic device or control the cover to lock or close the chassis, lest components and parts in the chassis should be exposed to an external environment. Or, the operator may open the cover in order to arrange or maintain or repair the components in the chassis.

For example, U.S. Pat. No. 11,297,730 B1 discloses a tool free removable chassis cover, U.S. Pat. No. 7,201,407 B2 discloses a sliding panel latch, U.S. Pat. No. 6,145,352 discloses a slam latch with opposing slides, CN 110388148A discloses a latch device, CN 115961844A discloses a latch device, which is a corresponding application of TW 110138018 entitled “latch device”), CN 219754305U discloses a latch, and TW 112139241 discloses a latch device with improved structure. All these patents provide typical embodiments of latch device.

The above conventional latch devices usually includes a shell, an actuating handle, and a sliding plate. The shell has a push button provided at one end thereof. The actuating handle has a pivotal end with a spring fitted thereto for pivotally connecting to another end of the shell. The actuating handle further has a link bar pivotally connected to an inner side of another end thereof and a protrusion provided on the other end. The protrusion can be inserted into the push button to form a locked state. When an operator operates the push button to release the protrusion, the spring pushes the actuating handle to open it and causes the sliding plate to move and the link bar to lift the actuating handle. Some of the above-mentioned invention patent applications, such as CN 110388148A entitled a latch device and CN 219754305U entitled a latch, have disclosed particular embodiments of the prior art latch devices.

An issue about the operation and the application of the latch devices having the conventional structural configuration is that the actuating handle and the push button are simultaneously arranged on the shell having a fixed length or specification, such that the actuating handle has to decrease its length, which inevitably prevents the actuating handle from being operated conveniently.

To improve the above disadvantageous condition, some of the conventional latch devices, such as the latch device disclosed in TW 110138018 and the latch device with improved structure disclosed in TW 112139241, all include a shell, an actuating handle, and a sliding plate. These embodiments include a shell and an actuating member, a linking member, and a sliding member mounted on the shell. The actuating member has a free end and a pivotal end fitted with an elastic member for pivotally connected to the shell, such that the actuating member is movable in a reciprocating motion. The free end of the actuating member defines an open area for a movable handling member to mount therein. The linking member includes a first end pivotally connected to an inner area of the free end of the actuating member (or the handling member), and a second end connected to the sliding member. When the operator pushes against the handling member for the same to swing, the actuating member is allowed to move from a closed position to an opened position, so that the linking member and the sliding member are brought to move along with the actuating member.

In the above-mentioned embodiments, the handling member is directly connected to the actuating member. With this arrangement, the actuating member may have a length being extendable as long as possible and thereby being much longer than that of the conventional latch device. This enables the actuating member, the linking member and the sliding member to move smoothly and improves the problem in the conventional latch device that the structural length/specification of the latch device is limited by the arrangement space/volume available from the latch device.

A problem about the structure and handling of the embodiment having the above configuration is that the first end of the linking member is pivotally connected to the top inner area of the actuating member. This arrangement would hinder the operator from moving the actuating member toward the opened position. That is, when the operator operates the actuating member to move it toward the opened position, the first end of the linking member and the area of the linking member located at the inner area of the actuating member would move along with the actuating member. This condition would apparently reduce the area or space available for the operator to hold or operate the actuating member and accordingly, disadvantageously prevents the actuating member from operating smoothly or conveniently.

Another problem about the structure and handling of the embodiment having the above configuration is, when the first end of the linking member is pivotally connected to the top inner area of the actuating member, the available maximum open angle of the actuating member is undesirably reduced.

Generally speaking, the above references all discuss about the structural combinations and applications of the conventional latch devices or other similar fastening mechanism. In the case these structural combinations of the conventional latch devices and the structure of the conventional actuating handle can be redesigned to have different structure and handling manner, it is able to increase the application effect of the latch device.

It is desirable to work out a fastener device or latch device with better structure to overcome or improve the above-mentioned problems while taking the following design factors into consideration:
1. Let the actuating handle or the actuating member have a length larger than that of the conventional latch device without changing the structural (shell) length or specification. Therefore, the structural configuration of the new latch device must include a press handling structure that can be directly connected to the actuating handle or the actuating member, such that the press handling structure and the actuating handle (or the actuating member) can move smoothly without influencing or reducing the length of the actuating handle.
2. Work out an improved structure that can overcome the problem in the conventional latch device that the pivotal connection of the linking member to the top inner area of the actuating member would reduce the area or space available for the operator to hold or operate the actuating member. Also consider an improved structure that increases the maximum open angle or open span of the actuating member.

All the above-mentioned references have not yet discussed, taught, or specifically disclosed the above issues.

### SUMMARY OF THE INVENTION

A primary object of the present invention is to provide a latch device that includes a shell and an actuating lever, a linking member and a sliding member mounted in the shell. The actuating lever has a free end and a pivotal end pivotally connected to the shell, such that the actuating lever is movable, rotatable or swingable in a reciprocating motion. The free end of the actuating lever has two cantilever arms formed thereat, and an open area is defined between the cantilever arms for a handling member and an elastic element to mount therein. The linking member has a first end pivotally connected to a middle area of the actuating lever located between the free end and the pivotal end and farther away from the free end; and a second end assembled to the shell. When an operator pulls or pushes the handling member, the actuating lever can be moved from a closed position to an opened position and bring the linking member and the sliding member to move along with the actuating lever. With these arrangements, the latch device of the present invention has a relatively larger open angle and longer handling area, compared to the prior art latch device, and can be smoothly or conveniently operated.

According to the latch device of the present invention, the pivotal end of the actuating lever has two secondary cantilever arms formed thereat, and a secondary open area defined between the two secondary cantilever arms for the linking member to set or mount therein. Further, the secondary open area is provided with a pair of secondary pin holes. When a secondary shaft pin is pivotally connected to a first end of the linking member, the linking member is movable or swingable along with the actuating lever. With these arrangements, the actuating lever has a maximum open angle larger than that of the prior art latch device.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a latch device according to a preferred embodiment of the present invention;

FIG. 2 is another perspective view of the latch device of FIG. 1 showing an actuating lever thereof is in an opened position;

FIG. 3 is an exploded perspective view of the latch device of FIG. 1 showing the structure of a shell, the actuating lever, a linking member, a sliding member, an elastic member, and an elastic element of the latch device;

FIG. 4 is an assembled sectional side view of the latch device of FIG. 1 showing a locating section of a handling member of the latch device is engaged with the shell, so that the actuating lever is located at a closed position;

FIG. 5 is another assembled sectional side view of the latch device of FIG. 1 showing an example of handling the latch device of the present invention, wherein an operator pulls the handling member for the same to compress the elastic element and move the locating section away from a secondary locating section on the shell;

FIG. 6 is another sectional side view of the latch device of FIG. 1 showing a further example of handling the latch device of the present invention, wherein the elastic member drives the actuating lever upward to the opened position, so as to bring the linking member and the sliding member to move;

FIG. 7 is an exploded perspective view of a derivative embodiment of the present invention showing the actuating lever has a locking mechanism provided thereon;

FIG. 8 is an assembled sectional side view of the latch device of FIG. 7 showing an example of handling the latch device of the present invention, wherein an operator pulls the handling member for the same to compress the elastic element and move the locating section away from the secondary locating section on the shell; and

FIG. 9 is a another sectional side view of the latch device of FIG. 7 showing a further example of handling the latch device of the present invention, wherein the elastic member drives the actuating lever upward to the opened position, so as to bring the linking member and the sliding member to move.

### DETAILED DESCRIPTION OF THE PREFERRED EMBODIMENTS

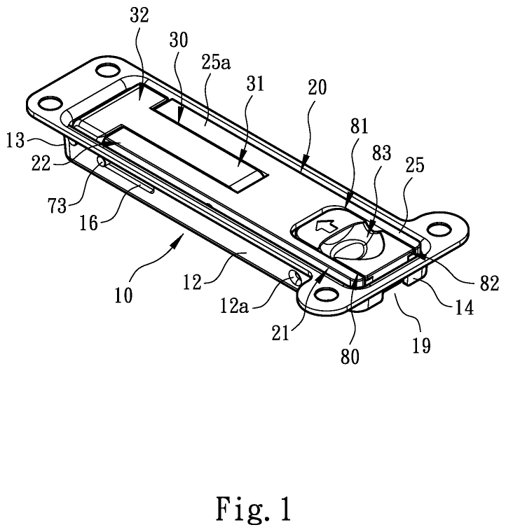

Please refer to FIGS. 1, 2 and 3. A latch device with improved structure according to a preferred embodiment of the present invention includes an assembly of a shell, an actuating lever, a linking member, and a sliding member, which are herein denoted by reference numerals 10, 20, 30 and 40, respectively. The shell 10 includes a bottom wall 11, two side walls 12 extended in parallel to an axis direction of the shell 10, and a primary end wall 13 and a secondary end wall 14 connected to the two side walls 12 and extended perpendicular to the axis direction of the shell 10. The bottom wall 11, the side walls 12, the primary end wall 13, and the secondary end wall 14 together define the shell 10. The shell 10 internally defines an open chamber 15, in which the actuating lever 20, the linking member 30, and the sliding member 40 are received.

In the description herein, positions indicated by the terms “upper part/side”, “above”, “lower part/side”, “below”, “right side”, “left side”, “lateral side”, etc. are positions viewed in front of the drawings.

In FIGS. 1, 2 and 3, it is shown the shell 10 has an elongate slot 16 provided on each of the two side walls 12, a cut opening 18 formed at the primary end wall 13, and a secondary locating section 19 having a cut opening formed at the secondary end wall 14. Further, the side walls 12 of the shell 10 respectively have a protruded structure 12a provided on an inner surface of the side walls 12; and the protruded structures 12a serve to help the sliding member 40 to move smoothly in the open chamber 15 of the shell 10.

In the illustrated preferred embodiment, the actuating lever 20 is in the form of a plate that defines an axis direction X, a free end 21, and a pivotal end 22 pivotally connected to the shell 10 via an elastic member 50, such that the actuating lever 20 is reciprocatingly movable or swingable relative to the shell 10.

Specifically, the free end 21 of the actuating lever 20 is formed into two parallelly projected cantilever arms 25 in the axis direction X with an open area 26 defined between the two cantilever arms 25. A pair of rails 95 is provided on two inner sides of the two cantilever arms 25 to extend in parallel to the axis direction X of the actuating lever 20; and two pin holes 27 are provided at the free end 21 or tail portions of the cantilever arms 25 for a shaft pin 77 to correspondingly pivotally connect thereto.

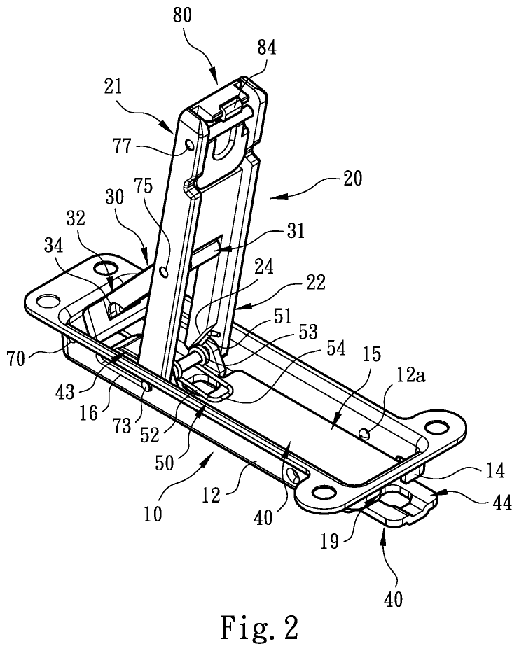

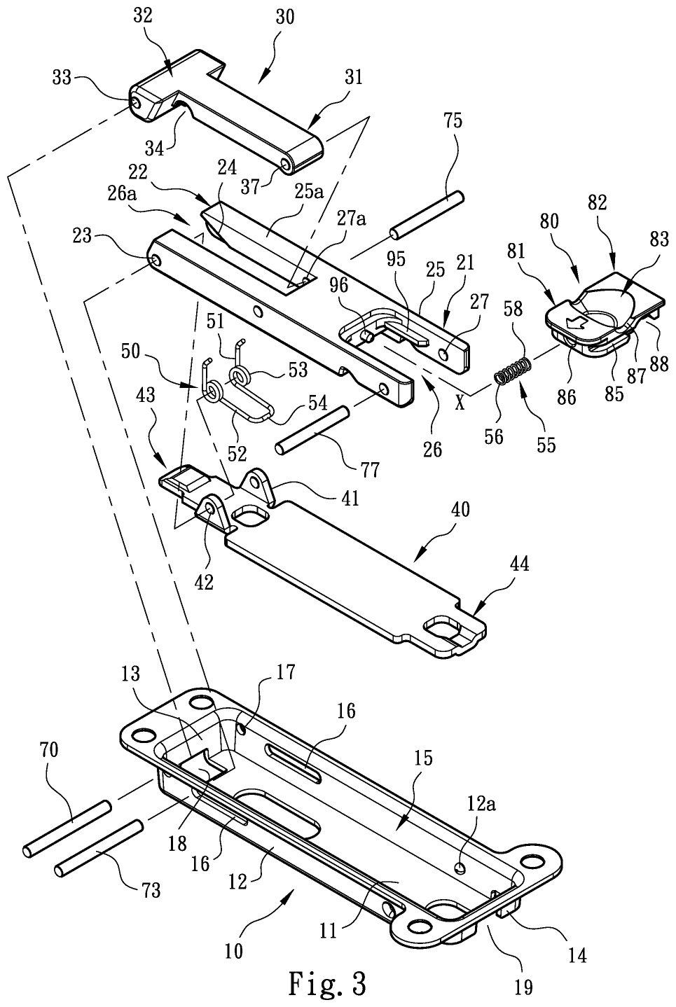

As shown in FIGS. 2 and 3, the pivotal end 22 of the actuating lever 20 is formed into two secondary cantilever arms 25a with a secondary open area 26a defined between the two secondary cantilever arms 25a. The linking member 30 is received or set in the secondary open area 26a. Further, the pivotal end 22 of the actuating lever 20 has a shaft receiving section 23 provided thereat.

In the illustrated preferred embodiment, the secondary open area 26a is located adjacent to the shaft receiving section 23. An area on the actuating lever 20 located distant from the free end 21 (i.e. a middle area or a lower area of the actuating lever 20 located adjacent to the secondary cantilever arms 25a or the secondary open area 26a) is provided with a pair of secondary pin holes 27a for receiving a secondary shaft pin 75. The secondary shaft pin 75 is pivotally connected to a first end 31 of the linking member 30, such that the linking member 30 is movable or swingable along with the actuating lever 20. With this arrangement, the actuating lever 20 of the latch device according to the present invention can be pulled open to a maximum angle (or can have a maximum open angle) that is greater than that of the actuating handle/member in the prior art latch device.

It is also shown an area of the actuating lever 20 located adjacent to the shaft receiving section 23 has a slant pressing section (or beveled edge) 24 for pressing against the elastic member 50 and accordingly, assisting the actuating lever 20 to move.

Specifically, the elastic member 50 can be selectively in the form of a torsion spring and includes a pair of coiled sections 53 having two opposed ends each, a pair of first projected sections 51 and a pair of second projected sections 52 connected to the opposed ends of the two coiled sections 53, and an extended section 54 perpendicularly connected to between the second projected sections 52. Further, the shaft receiving section 23 of the actuating lever 20 has a shaft bar 73 assembled thereto, such that the shaft bar 73 extends through and engages with the coiled sections 53 of the elastic member 50 and the elongate slots 16 formed on the side walls 12 of the shell 10. The first projected sections 51 of the elastic member 50 are pressed against the slant pressing section 24, and the second projected sections 52 and/or the extended section 54 are pressed against the sliding member 40, such that the actuating lever 20 can be pivotally turned about the shaft rod 73 and/or the shaft receiving section 23 while the actuating lever 20 or the pivotal end 22 thereof is allowed to move or swing reciprocatingly in along the elongate slots 16 on the shell 10.

In the illustrated preferred embodiment, the actuating lever 20 includes an assembling section 96 provided on an inner edge of the open area 26 or at tail portions of the cantilever arms 25 located farther away from the free end 21. An elastic element 55 is assembled or held to the assembling section 96. The assembling section 96 may be in the form of a protruded post or a hole. Further, in the open area 26, there is mounted a handling member 80 and the elastic element 55 that assists the handling member 80 to move reciprocatingly in the axis direction X of the actuating lever 20.

Specifically, the handling member 80 includes a primary part 81 and a secondary part 82 located at two axially opposite ends of a base portion 83. The base portion 83 is in the form of a recessed structure and/or has two recesses 87 provided at two sides of the base portion 83 to communicate with the recessed structure, enabling the operator to more easily pull or push the handling member 80 to move. The handling member 80 is provided at bottom areas located adjacent to a locating section 84 with a pair of secondary recesses 88, which cooperates with the shaft pin 77 to define a distance or range within which the handling member 80 can be moved. The handling member 80 has a pair of secondary rails 85 provided on two lateral edges in correspondence to the pair of rails 95 provided on the two cantilever arms 25. When the secondary rails 85 are assembled to the rails 95, the handling member 80 can move reciprocatingly or linearly in the axis direction X more smoothly to ensure that the handling member 80 is always located at a correct position in the open area 26 or between the two cantilever arms 25 in the whole moving process of the actuating lever 20.

Further, the handling member 80 or the primary part 81 is provided with a secondary assembling section 86, which may be a hole or a protrusion for receiving or engaging with the elastic element 55. The locating section 84 is provided at the secondary part 82 and has a hook-like configuration. When the actuating lever 20 is in a closed position or the actuating lever 20 is closed to the shell 10, the locating section 84 is engaged with or caught by the secondary locating section 19, so that the actuating lever 20 or the handling member 80 is immovably set in or locked to the shell 10.

In an operable embodiment, the elastic element 55 is a coil spring or other elastic structures. The elastic element 55 includes a first end 56 held to or assembled to the assembling section 96 and a second end 58 received in or pressed against the secondary assembling section 86, such that the handling member 80 can move reciprocatingly and the locating section 84 and the secondary locating section 19 can maintain a mutually engaged state.

In FIG. 3, the linking member 30 is shown as a T-shaped member having a first end 31 and a second end 32. The first end 31 of the linking member 30 is provided with a pair of pin holes 37, to which the secondary shaft pin 75 is pivotally connected, such that the first end 31 of the linking member 30 is pivotally connected to the secondary pin hole 27a on the actuating lever 20 in a freely rotatable or swingable state.

In the illustrated preferred embodiment, the second end 32 of the linking member 30 is provided with a secondary shaft receiving section 33, to which a shaft 70 is pivotally connected, such that the second end 32 of the linking member 30 is in a freely movable or rotatable state. Further, the second end 32 of the linking member 30 or an area on the linking member 30 located adjacent to the secondary shaft receiving section 33 is provided with a recessed section 34 for receiving the coiled section 53 of the elastic member 50 therein. The shaft 70 assembled to the secondary shaft receiving section 33 of the linking member 30 is also pivotally connected to shaft holes 17 formed on the shell 10.

In FIGS. 1, 2 and 3, the sliding member 40 is in the form of a plate mounted on the shell 10 or in the chamber 15 and is in a freely movable state. The sliding member 40 has a primary end 43 and a secondary end 44 defined thereon. The sliding member 40 is provided between the primary end 43 and the secondary end 44 with an upward protruded assembling section 41 and a pair of shaft holes 42 formed on the assembling section 41.

Therefore, the shaft bar 73 can be extended through the shaft receiving section 23 on the actuating lever 20, the shaft holes 42 on the sliding member 40, and the coiled sections 53 of the elastic member 50 with two ends of the shaft rod 73 pivotally connected to the elongate slots 16 formed on the shell 10. When the operator operates or pulls the handling member 80 to move in the axis direction X, the actuating lever 20 can be moved from a closed position to an opened position and the linking member 30 is brought to move along with the actuating lever 20. At this point, the shaft bar 73 is driven to move in and along the elongate slots 16 and bring the actuating lever 20 or the pivotal end 22 of the actuating lever 20 to move and rotate simultaneously, such that the sliding member 40 is brought to move.

The above-mentioned closed position means a position in which the actuating lever 20 and the linking member 30 are received in the shell 10 or the open chamber 15; and the above-mentioned opened position means a position in which the actuating lever 20 or the free end 21 and the linking member 30 or the first end 31 are moved away from the shell 10.

It is understood the range or the angle within which the actuating lever 20 can be moved relative to the shell 10 to the opened position or the closed position is controllable via a distance between the shaft receiving section 23 and the secondary shaft pin 27a on the actuating lever 20, a distance between the secondary shaft receiving section 33 and the pin holes 37 on the linking member 30, and a distance by which the sliding member 40 can move (i.e. the length of the elongate slot 16 or a distance by which the shaft bar 73 can move).

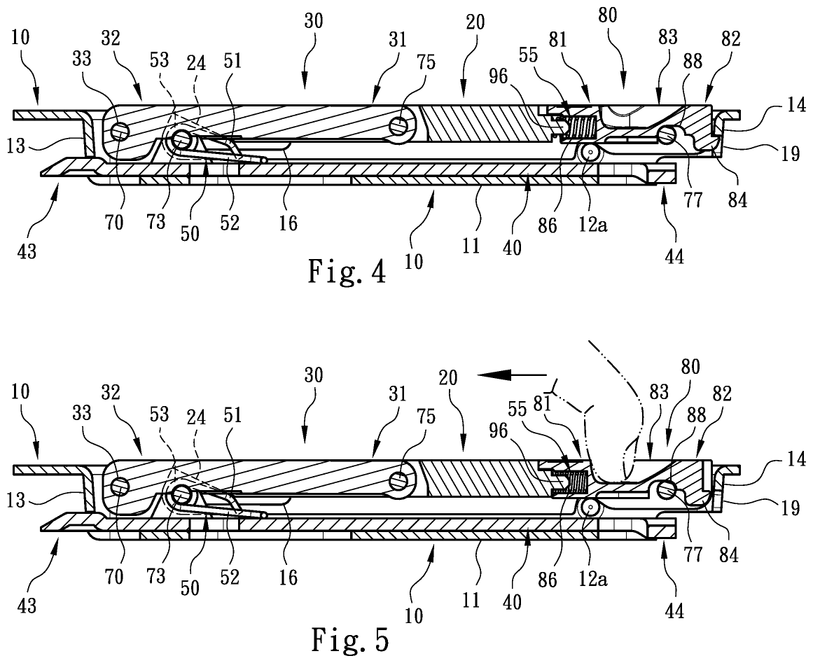

FIG. 4 shows the locating section 84 on the handling member 80 is engaged with or caught by the secondary locating section 19 on the shell 10, so that the actuating lever 20, the linking member 30 and the sliding member 40 are in the closed position and located in the shell 10 or the open chamber 15 while the elastic member 50 is pressed by the pressing section 24 of the actuating lever 20 to store elastic energy.

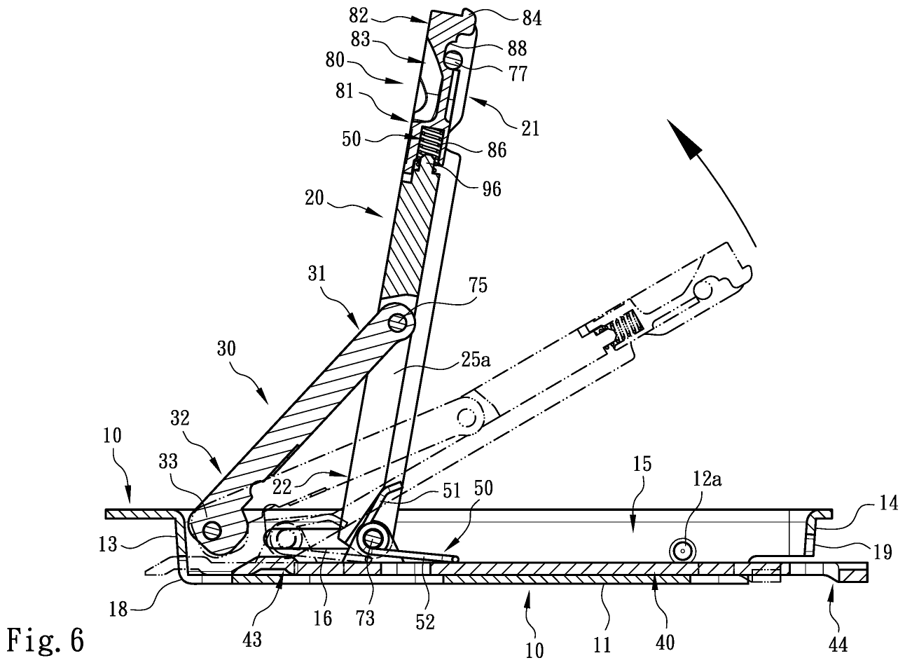

Please refer to FIG. 5. When the operator applies a force to the base portion 83 to pull the handling member 80 to move leftward in the axis direction X, as indicated by the arrow in FIG. 5, the handling member 80 is caused to push against the elastic element 55 for the latter to store elastic energy and the locating section 84 is moved away from the secondary locating section 19 of the shell 10. At this point, the elastic member 50 releases its stored elastic energy to push the actuating lever 20 to move and rotate toward the opened position while the linking member 30 and the sliding member 40 are brought by the turning actuating lever 20 to move at the same time, as shown in FIG. 6.

FIG. 6 also shows the actuating lever 20 or its pivotal end 22, which is held to the elongate slots 16 by the shaft bar 73, to rotate or swing and bring the sliding member 40 to move between the primary end wall 13 (or the cut opening 18) and the secondary end wall 14 of the shell 10.

In an operable embodiment, when the actuating lever 20 is closed to the shell 10, a part of the primary end 43 of the sliding member 40 is protruded from the cut opening 18 formed at the primary end wall 13 of the shell 10. When the actuating lever 20 is located at the opened position, the secondary end 44 of the sliding member 40 is correspondingly brought to protrude from the secondary end wall 14 of the shell 10.

It is understood that, with the linking member 30 being connected to the secondary cantilever arms 25a or received in the secondary open area 26a of the actuating lever 20, the linking member 30 can move (i.e. the linking member 30 located behind the actuating lever 20 can move along with the actuating lever 20) without not hindering any handling or gripping area or a lower side of the actuating lever 20. This arrangement correspondingly enables the actuating lever 20 to provide a relatively large operating space for the operator to grip the actuating lever 20 with one hand. Further, the first end 31 of the linking member 30 is pivotally connected to a substantially middle area or an area close to a lower part of the actuating lever 20.

This also allows the actuating lever 20 to have an open angle or a moving angle larger than that can be provided by a prior art actuating handle.

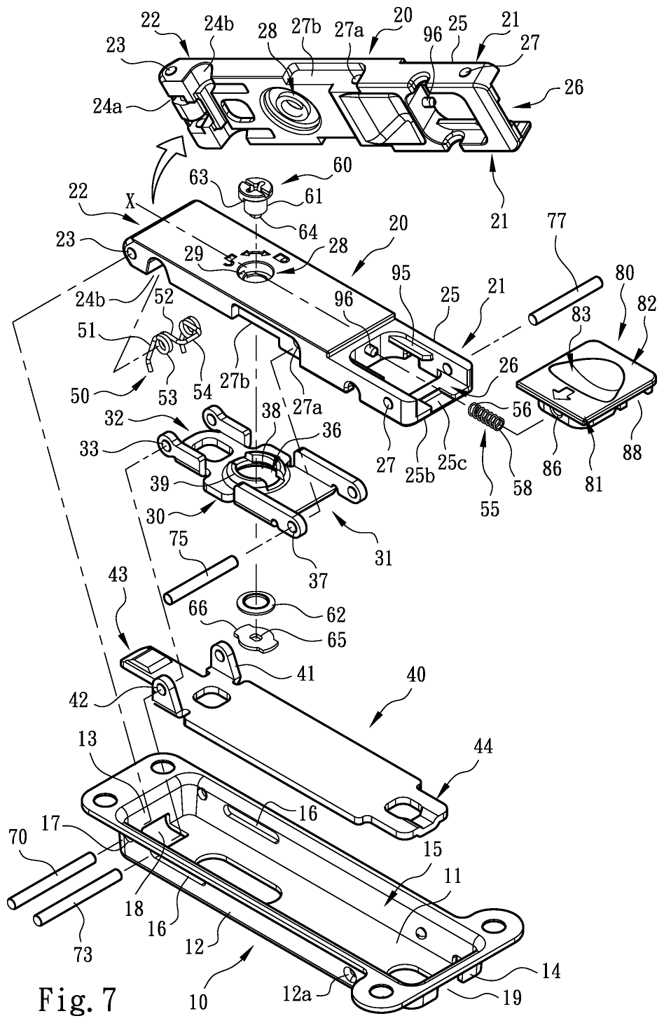

Please refer to FIGS. 7, 8 and 9. In a derivative embodiment of the present invention, the pivotal end 22 of the actuating lever 20 is pivotally connected to the shell 10 via the elastic member 50, allowing the actuating lever 20 to swing in a reciprocating motion (or in a simple harmonic motion).

Specifically, in the derivative embodiment, the actuating lever 20 further includes a secondary recessed section 24a formed at the pivotal end 22 (or the shaft receiving section 23) to assist in assembling or locating of the elastic member 50 to the actuating lever 20. The actuating lever 20 is also provided with a notch section 24b located adjacent to the shaft receiving section 23. Further, the shaft 70 is extended through the shaft receiving section 23, the coiled sections 53 of the elastic member 50, and the shaft holes 17 provided on the side walls 12 of the shell 10, such that the first projected sections 51 of the elastic member 50 are pressed against the bottom wall 11 of the shell 10 and the second projected sections 52 of the elastic member 50 are pressed against the actuating lever 20 (or the shaft receiving section 23), allowing the actuating lever 20 to rotate about the shaft 70 and/or the shaft holes 17 and the shaft receiving section 23 in a reciprocating or swinging motion.

As shown in FIG. 7, a pair of secondary pin holes 27a is provided at an area on the actuating lever 20 between the free end 21 and the pivotal end 22 (i.e. an area farther away from the shaft receiving section 23 or an area farther away from the free end 21) and a secondary shaft pin 75 is pivotally connected to the first end 31 of the linking member 30, such that the linking member 30 is movable (or swingable) along with the actuating lever 20. Further, a pair of elongate slot sections 27b is formed at areas on two middle lateral sides of the actuating lever 20 and located adjacent to the secondary pin holes 27a. The elongate slot sections 27b are used to receive or allow for the admittance of two lateral walls of the linking member 30.

In the illustrated derivative embodiment, the pin holes 37 at the first end 31 of the linking member 30 are pivotally connected to the secondary shaft pin 75. Further, the secondary shaft receiving section 33 at the second end 32 of the linking member 30 is pivotally connected to the shaft bar 73, such that the second end 32 of the linking member 30 can move or rotate freely. When the actuating lever 20 is in the closed position, the secondary shaft receiving section 33 is received in the notch section 24b. Further, the shaft bar 73 is pivotally connected to the assembling section 41 (or the shaft holes 42) of the sliding member 40 with two ends of the shaft bar 73 being pivotally connected to the elongate slots 16 on the shell 10.

When the operator operates or pulls the handling member 80 to move in the axis direction X, the actuating lever 20 is brought to move from the closed position to the opened position. Meanwhile, the linking member 30 is also brought to move, such that the shaft bar 73 is moved in and along the elongate slots 16 and brings the sliding member 40 to move.

It is understood that, in the prior art latch device, when the actuating handle (member) is being opened, there would have a vertically downward component of force toward the closed position. In the latch device of the present invention, when the secondary shaft pin 75 is pivotally connected to the middle area of the movable actuating lever 20 (or an area on the movable actuating lever 20 closer to the shaft receiving section 23) and to the first end 31 of the linking member 30, the secondary shaft pin 75 can serve as a pivot point for the actuating lever 20 to move, shift or swing about it to the opened position and be less influenced by the above-mentioned component of force.

Please refer to FIGS. 7, 8 and 9. In the derivative embodiment, a connecting arm 25b is provided at a tail portion of the cantilever arms 25 at the free end 21 of the actuating lever 20 to define a secondary notch section 25c on the connecting arm 25b. The connecting arm 25b and the secondary notch section 25c are provided to assist in limiting the handling member 80 to move within a predetermined distance or range. A through hole 28 with a restricting section 29 is formed on the actuating lever 20 between the free end 21 and the pivotal end 22; and a locking mechanism 60 is mounted in the through hole 28. The locking mechanism 60 includes a fastening element 61 received in the through hole 28 and a corresponding fastening plate 62 pivotally connected to the fastening element 61.

As can be seen in FIG. 7, the fastening element 61 includes a secondary restricting section 63 and a shank 64 in the form of an extended shaft. The fastening plate 62 can be assembled to or integrally formed with a winged element 66, which includes an engaging section 65 in the form of a hole. After the locking mechanism 60 is mounted in the through hole 28, the shank 64 is downward protruded from the through hole 28 to pivotally connect to the engaging section 65. When the operator drives the fastening element 61 to rotate, the restricting section 29 formed on the actuating lever 20 would abut against the secondary restricting section 63 to thereby limit the fastening element 61 to rotate within a predetermined angle or range.

In the derivative embodiment, the linking member 30 is provided between the first end 31 and the second end 32 with a locking hole 36 corresponding to the locking mechanism 60. The locking hole 36 allows the fastening plate 62 or the winged element 66 to pass therethrough. The locking hole 36 is cooperatively located on around a top of a through hole 38 formed on the linking member 30 to thereby form a raised annular portion 39.

It is understood that, when the locking mechanism 60 is in a locked state, the winged element 66 is retained to the locking hole 36 or the raised annular portion 39, such that the actuating lever 20, the linking member 30, and the sliding member 40 are held to the closed position in the shell 10 or the chamber 15 defined in the shell 10. On the other hand, when the operator turns the fastening element 61 to release the winged element 66 from the locking hole 36 of the linking member 30, the locked state of the locking mechanism 60 is changed to an unlocked state.

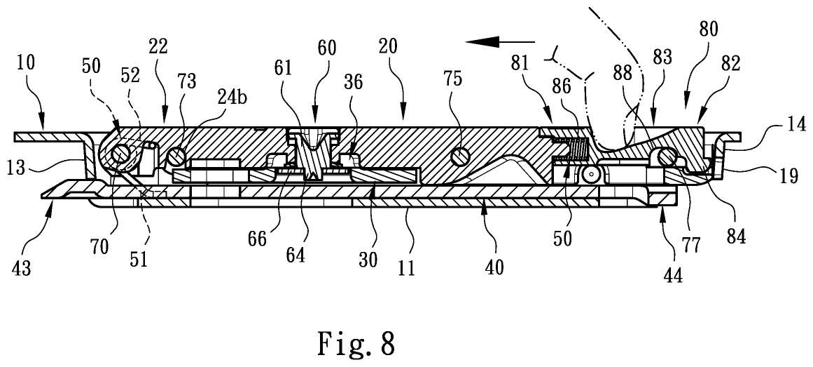

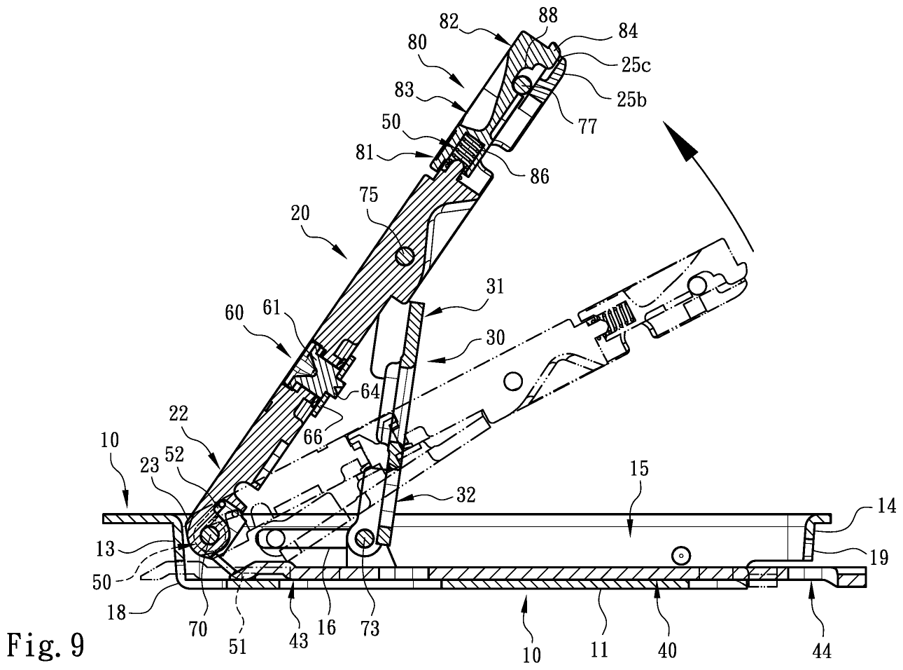

Please refer to FIGS. 8 and 9. When the operator applies a force to the base portion 83 with a finger to pull the handling member 80 to move leftward in the axis direction X, as indicated by the arrow in FIG. 8, the handling member 80 is caused to push against the elastic element 55 for the latter to store elastic energy and the locating section 84 is moved away from the secondary locating section 19 of the shell 10. At this point, the elastic member 50 releases its stored elastic energy to push the actuating lever 20 to move toward the opened position while the linking member 30 is brought by the moving actuating lever 20 to move at the same time, as shown in FIG. 9.

FIG. 8 also shows the actuating lever 20 causes the second end 32 of the linking member 30 to bring the shaft bar 73 to move in and along the elongate slots 16, and also causes the sliding member 40 to move between the primary end wall 13 (or the cut opening 18 formed at the primary end wall 13) and the secondary end wall 14 of the shell 10.

Generally speaking, the latch device according to the present invention has the following advantages, compared to the prior art latch device:
1. In the preferred embodiment of the present invention, the shell 10, the actuating lever 20, the linking member 30, the sliding member 40, and other related components are structurally redesigned. For instance, the actuating lever 20 is provided at its free end 21 with two cantilever arms 25 and an open area 26 for mounting the handling member 80 thereto, and at its pivotal end 22 with two secondary cantilever arms 25a and a secondary open area 26a for connecting to the linking member 30, such that the actuating lever 20 is movable and rotatable or swingable. In a derivative embodiment, the actuating lever 20 is provided at its pivotal end 22 with a secondary recessed section 24a and a notch section 24b to helpfully receive the elastic member 50 (or the coiled sections 53) and the secondary shaft receiving section 33 and the shaft bar 70 therein. The actuating lever 20 further has a pair of elongate slot sections 27b formed at lateral sides thereof, and has a connecting arm 25b and a secondary notch section 25c provided at the open area 26. All these arrangements are significantly different from the prior art latch device to change the structure or the component assembling relation of the conventional latch device, so that the latch device of the present invention is different from the conventional latch device in terms of its usage and operation.
2. While the structure or the shell of the latch device of the present invention and the prior art latch device are the same in length or specification, the actuating lever 20 (or actuating handle) can have a length larger than that of the conventional latch device. Further, the latch device of the present invention can have a pressing operating structure or the handling member 80 directly provided on the actuating lever 20 without affecting or decreasing an overall length of the actuating lever (or handle), allowing the latch device of the present invention to operate smoothly and stably.
3. In the prior art latch device, the linking member is pivotally connected

to a top inner area of the actuating lever. With this arrangement, the area or space available for the operator to hold or operate the actuating lever is reduced. On the other hand, in the present invention, the actuating lever and the linking member 30 are assembled in a manner that not only overcomes the problem in the prior art latch device, but also increases the maximum open angle of the actuating lever. In addition, the use of the secondary open area 26a to receive the linking member 30 can also reduce superposed components that have adverse influence on the height or volume of the entire latch device.

In brief, the above-described structural arrangements provide highly effective improvements on the latch device of the present invention, making it have a spatial configuration different from and superior advantages than the prior art latch 5 device. With these improvements, the prevent invention fully meets the criteria of granting it a patent.

The present invention has been described with some preferred embodiments thereof and it is understood that many changes and modifications in the described 10 embodiments can be carried out without departing from the scope and the spirit of the invention that is intended to be limited only by the appended claims.

What is claimed is:

1. A latch device, comprising a shell (10) and an assembly of an actuating lever (20), a linking member (30) and a sliding member (40) mounted on the shell (10);
the shell (10) being provided on each of two side walls (12) with an elongate slot (16);
the actuating lever (20) defining an axis direction (X), a free end (21), and a pivotal end (22) pivotally connected to the shell (10); and the pivotal end (22) of the actuating lever (10) being provided with a shaft receiving section (23) for an elastic member (50) to assemble thereto, such that the actuating lever (20) is movable in a reciprocating motion;
the free end (21) of the actuating lever (20) being provided with two cantilever arms (25) and an open area (26) defined between the two cantilever arms (25); a handling member (80) and an elastic element (55) being mounted in the open area (26), and the elastic element (55) being used to assist the actuating lever (20) to move in the axis direction (X) in a reciprocating motion; and
the linking member (30) having a freely rotatable first end (31) and a second end (32) connected to the sliding member (40); and the sliding member (40) defining a primary end (43) and a secondary end (44); and
an area on the actuating lever (20) located distant from the free end (21) being provided with a pair of secondary pin holes (27a) for receiving a secondary shaft pin (75) therein; the secondary shaft pin (75) being pivotally connected to the first end (31) of the linking member (30), such that when the handling member (80) is moved in the axis direction (X), the actuating lever (20) is allowed to move from a closed position to an opened position and brings the linking member (30) and the sliding member (40) to move along with the actuating lever (20).

2. The latch device as claimed in claim 1, wherein the shell (10) includes a bottom wall (11), two side walls (12) extending in parallel to an axis direction of the shell (10), and a primary end wall (13) and a secondary end wall (14) connected to the two side walls (12) and extending perpendicular to the axis direction of the shell (10); the bottom wall (11), the side walls (12), the primary end wall (13), and the secondary end wall (14) together forming the shell (10), and the shell (10) internally defining an open chamber (15), in which the actuating lever (20), linking member (30) and the sliding member (40) are mounted;
the primary end wall (13) of the shell (10) having a cut opening (18) formed thereat, and the secondary end wall (14) of the shell (10) having a secondary locating section (19) with a cut opening formed thereat;
a pair of rails (95) being provided on two inner sides of the two cantilever arms (25) to extend in parallel to the axis direction (X) of the actuating lever (20); and
two pin holes (27) being provided at tail portions of the two cantilever arms (25) for a shaft pin (77) to correspondingly pivotally connect thereto;
an assembling section (96) being provided on an area of the open area (26) of the actuating lever (20) opposed to the cantilever arms (25) for the elastic element 55 to mount thereto; and the assembling section (96) being formed as one of a protruded post and a hole;
the handling member (80) including a base portion (83) to facilitate easy operating of the handling member (80) by an operator, and a primary part (81) and a secondary part (82) located at two opposite ends of the base portion (83); and
the base portion (83) being in the form of a recessed structure and having two recesses 87 formed at two sides of the base portion (83) and communicable with the recessed structure;
the handling member (80) being provided on two lateral sides with a pair of secondary rails (85); and the handling member (80) further including a secondary assembling section (86) for engaging with the elastic element (55);
the secondary part (82) of the handling member (80) having a hook-like locating section (84) provided thereat; the locating section (84) being caught and held in place by the secondary locating section (19) on the shell (10) when the actuating lever (20) is in the closed position; and the handling member (80) further including a pair of secondary recesses (88) formed at bottom areas of the handling member (80); and
the elastic element 55 being selectively in the form of a coil spring and including a first end (56) assembled to the assembling section (96) and a second end (58) pressed against the secondary assembling section (86).

3. The latch device as claimed in claim 1, wherein the actuating lever (20) includes a secondary recessed section (24a) provided at the shaft receiving section (23) for receiving the elastic member (50) therein; and a notch section (24b) provided at an area located adjacent to the shaft receiving section (23);
the secondary pin hole (27a) being provided at a middle area of the actuating lever (20); and a pair of elongate slot sections (27b) being formed at areas on two middle lateral sides of the actuating lever (20) and located adjacent to the secondary pin holes (27a) for receiving two lateral walls of the linking member (30);
the free end (21) of the actuating lever (20) being provided at tail portions of the cantilever arms (25) with a connecting arm (25b) and a secondary notch section (25c) connected to the connecting arm (25b);
the elastic member (50) being selectively in the form of a torsion spring and including two coiled sections (53) having two opposed ends each, a pair of first projected sections (51) and a pair of second projected sections (52) connected to the opposed ends of the coiled sections (53), and an extended section (54) perpendicularly connected to the two second projected sections (52); and
the shaft receiving section (23) having a shaft (70) assembled thereto, such that the shaft (70) extends through the coiled sections (53) of the elastic member (50) and the shaft holes (17) formed on the side walls (12) of the shell (10) with the first projected sections (51) of the elastic member (50) pressed against the bottom wall (11) of the shell (10) and the second projected sections (52) pressed against the shaft receiving section (23) of the actuating lever (20); and
the cantilever arms (25) of the actuating lever (20) extending in parallel to each other and being provided at tail portions with a pair of pin holes (27) for the shaft pin (77) to pivotally connect thereto.

4. The latch device as claimed in claim 2, wherein the actuating lever (20) includes a secondary recessed section (24a) provided at the shaft receiving section (23) for receiving the elastic member (50) therein; and a notch section (24b) provided at an area located adjacent to the shaft receiving section (23);
the secondary pin hole (27a) being provided at a middle area of the actuating lever (20); and a pair of elongate slot sections (27b) being formed at areas on two middle lateral sides of the actuating lever (20) and located adjacent to the secondary pin holes (27a) for receiving two lateral walls of the linking member (30);
the free end (21) of the actuating lever (20) being provided at tail portions of the cantilever arms (25) with a connecting arm (25b) and a secondary notch section (25c) connected to the connecting arm (25b);
the elastic member (50) being selectively in the form of a torsion spring and including two coiled sections (53) having two opposed ends each, a pair of first projected sections (51) and a pair of second projected sections (52) connected to the opposed ends of the coiled sections (53), and an extended section (54) perpendicularly connected to the two second projected sections (52); and
the shaft receiving section (23) having a shaft (70) assembled thereto, such that the shaft (70) extends through the coiled sections (53) of the elastic member (50) and the shaft holes (17) formed on the side walls (12) of the shell (10) with the first projected sections (51) of the elastic member (50) pressed against the bottom wall (11) of the shell (10) and the second projected sections (52) pressed against the shaft receiving section (23) of the actuating lever (20); and
the cantilever arms (25) of the actuating lever (20) extending in parallel to each other and being provided at tail portions with a pair of pin holes (27) for the shaft pin (77) to pivotally connect thereto.

5. The latch device as claimed in claim 1, wherein the secondary shaft pin (75) is pivotally connected to a pair of pin holes (37) formed on the first end (31) of the linking member (30), such that the first end (31) of the linking member (30) is freely movable;
a secondary shaft receiving section (33) being provided on the second end (32) of the linking member (30) for a shaft bar (73) to pivotally connect thereto, such that the second end (32) of the linking member (30) is freely movable; and the shaft bar (73) being also pivotally connected to the sliding member (40);
the sliding member (40) being in the form of a plate and including an upward protruded assembling section (41) provided between the primary end (43) and the secondary end (44) and a pair of shaft holes (42) formed on the assembling section (41); and
the shaft bar (73) being assembled to the second end (32) of the linking member (30) and the shaft holes (42) on the sliding member (40) with two ends of the shaft bar (73) being pivotally connected to the elongate slots (16) on the shell (10),
the actuating lever (20) is provided between the free end (21) and the pivotal end (22) with a through hole (28) and a restricting section (29) formed on the through hole (28); and
the through hole (28) having a locking mechanism (60) mounted therein; and the locking mechanism (60) including a fastening element (61) received in the through hole (28) and a fastening plate (62) pivotally connected to the fastening element (61);
the fastening element (61) including a secondary restricting section (63) and a shank (64) in the form of an extended shaft; the fastening plate (62) being assembled to a winged element (66), which includes an engaging section (65) in the form of a hole; and the shank (64) being pivotally connected to the engaging section (65); and
the linking member (30) being provided between the first end (31) and the second end (32) with a locking hole (36), which is located on around a top of a through hole (38) formed on the linking member (30) to thereby form a raised annular portion (39).

6. The latch device as claimed in claim 2, wherein the secondary shaft pin (75) is pivotally connected to a pair of pin holes (37) formed on the first end (31) of the linking member (30), such that the first end (31) of the linking member (30) is freely movable;
a secondary shaft receiving section (33) being provided on the second end (32) of the linking member (30) for a shaft bar (73) to pivotally connect thereto, such that the second end (32) of the linking member (30) is freely movable; and the shaft bar (73) being also pivotally connected to the sliding member (40);
the sliding member (40) being in the form of a plate and including an upward protruded assembling section (41) provided between the primary end (43) and the secondary end (44) and a pair of shaft holes (42) formed on the assembling section (41); and
the shaft bar (73) being assembled to the second end (32) of the linking member (30) and the shaft holes (42) on the sliding member (40) with two ends of the shaft bar (73) being pivotally connected to the elongate slots (16) on the shell (10),
the actuating lever (20) is provided between the free end (21) and the pivotal end (22) with a through hole (28) and a restricting section (29) formed on the through hole (28); and
the through hole (28) having a locking mechanism (60) mounted therein; and the locking mechanism (60) including a fastening element (61) received in the through hole (28) and a fastening plate (62) pivotally connected to the fastening element (61);
the fastening element (61) including a secondary restricting section (63) and a shank (64) in the form of an extended shaft; the fastening plate (62) being assembled to a winged element (66), which includes an engaging section (65) in the form of a hole; and the shank (64) being pivotally connected to the engaging section (65); and
the linking member (30) being provided between the first end (31) and the second end (32) with a locking hole (36), which is located on around a top of a through hole (38) formed on the linking member (30) to thereby form a raised annular portion (39).

7. The latch device as claimed in claim 3, wherein the secondary shaft pin (75) is pivotally connected to a pair of pin holes (37) formed on the first end (31) of the linking member (30), such that the first end (31) of the linking member (30) is freely movable;
a secondary shaft receiving section (33) being provided on the second end (32) of the linking member (30) for a shaft bar (73) to pivotally connect thereto, such that the second end (32) of the linking member (30) is freely movable; and the shaft bar (73) being also pivotally connected to the sliding member (40);
the sliding member (40) being in the form of a plate and including an upward protruded assembling section (41) provided between the primary end (43) and the secondary end (44) and a pair of shaft holes (42) formed on the assembling section (41); and
the shaft bar (73) being assembled to the second end (32) of the linking member (30) and the shaft holes (42) on the sliding member (40) with two ends of the shaft bar (73) being pivotally connected to the elongate slots (16) on the shell (10),
the actuating lever (20) is provided between the free end (21) and the pivotal end (22) with a through hole (28) and a restricting section (29) formed on the through hole (28); and
the through hole (28) having a locking mechanism (60) mounted therein; and the locking mechanism (60) including a fastening element (61) received in the through hole (28) and a fastening plate (62) pivotally connected to the fastening element (61);
the fastening element (61) including a secondary restricting section (63) and a shank (64) in the form of an extended shaft; the fastening plate (62) being assembled to a winged element (66), which includes an engaging section (65) in the form of a hole; and the shank (64) being pivotally connected to the engaging section (65); and
the linking member (30) being provided between the first end (31) and the second end (32) with a locking hole (36), which is located on around a top of a through hole (38) formed on the linking member (30) to thereby form a raised annular portion (39).

8. The latch device as claimed in claim 4, wherein the secondary shaft pin (75) is pivotally connected to a pair of pin holes (37) formed on the first end (31) of the linking member (30), such that the first end (31) of the linking member (30) is freely movable;
a secondary shaft receiving section (33) being provided on the second end (32) of the linking member (30) for a shaft bar (73) to pivotally connect thereto, such that the second end (32) of the linking member (30) is freely movable; and the shaft bar (73) being also pivotally connected to the sliding member (40);
the sliding member (40) being in the form of a plate and including an upward protruded assembling section (41) provided between the primary end (43) and the secondary end (44) and a pair of shaft holes (42) formed on the assembling section (41); and
the shaft bar (73) being assembled to the second end (32) of the linking member (30) and the shaft holes (42) on the sliding member (40) with two ends of the shaft bar (73) being pivotally connected to the elongate slots (16) on the shell (10),
the actuating lever (20) is provided between the free end (21) and the pivotal end (22) with a through hole (28) and a restricting section (29) formed on the through hole (28); and
the through hole (28) having a locking mechanism (60) mounted therein; and the locking mechanism (60) including a fastening element (61) received in the through hole (28) and a fastening plate (62) pivotally connected to the fastening element (61);
the fastening element (61) including a secondary restricting section (63) and a shank (64) in the form of an extended shaft; the fastening plate (62) being assembled to a winged element (66), which includes an engaging section (65) in the form of a hole; and the shank (64) being pivotally connected to the engaging section (65); and
the linking member (30) being provided between the first end (31) and the second end (32) with a locking hole (36), which is located on around a top of a through hole (38) formed on the linking member (30) to thereby form a raised annular portion (39).

9. The latch device as claimed in claim 1, wherein the actuating lever (20) is provided between the free end (21) and the pivotal end (22) with a through hole (28) and a restricting section (29) formed on the through hole (28); and
the through hole (28) having a locking mechanism (60) mounted therein; and the locking mechanism (60) including a fastening element (61) received in the through hole (28) and a fastening plate (62) pivotally connected to the fastening element (61);
the fastening element (61) including a secondary restricting section (63) and a shank (64) in the form of an extended shaft; the fastening plate (62) being assembled to a winged element (66), which includes an engaging section (65) in the form of a hole; and the shank (64) being pivotally connected to the engaging section (65); and
the linking member (30) being provided between the first end (31) and the second end (32) with a locking hole (36), which is located on around a top of a through hole (38) formed on the linking member (30) to thereby form a raised annular portion (39).

10. The latch device as claimed in claim 2, wherein the actuating lever (20) is provided between the free end (21) and the pivotal end (22) with a through hole (28) and a restricting section (29) formed on the through hole (28); and
the through hole (28) having a locking mechanism (60) mounted therein; and the locking mechanism (60) including a fastening element (61) received in the through hole (28) and a fastening plate (62) pivotally connected to the fastening element (61);
the fastening element (61) including a secondary restricting section (63) and a shank (64) in the form of an extended shaft; the fastening plate (62) being assembled to a winged element (66), which includes an engaging section (65) in the form of a hole; and the shank (64) being pivotally connected to the engaging section (65); and
the linking member (30) being provided between the first end (31) and the second end (32) with a locking hole (36), which is located on around a top of a through hole (38) formed on the linking member (30) to thereby form a raised annular portion (39).

11. The latch device as claimed in claim 3, wherein the actuating lever (20) is provided between the free end (21) and the pivotal end (22) with a through hole (28) and a restricting section (29) formed on the through hole (28); and
the through hole (28) having a locking mechanism (60) mounted therein; and the locking mechanism (60) including a fastening element (61) received in the through hole (28) and a fastening plate (62) pivotally connected to the fastening element (61);
the fastening element (61) including a secondary restricting section (63) and a shank (64) in the form of an extended shaft; the fastening plate (62) being assembled to a winged element (66), which includes an engaging section (65) in the form of a hole; and the shank (64) being pivotally connected to the engaging section (65); and
the linking member (30) being provided between the first end (31) and the second end (32) with a locking hole (36), which is located on around a top of a through hole (38) formed on the linking member (30) to thereby form a raised annular portion (39).

12. The latch device as claimed in claim 4, wherein the actuating lever (20) is provided between the free end (21) and the pivotal end (22) with a through hole (28) and a restricting section (29) formed on the through hole (28); and
the through hole (28) having a locking mechanism (60) mounted therein; and the locking mechanism (60) including a fastening element (61) received in the through hole (28) and a fastening plate (62) pivotally connected to the fastening element (61);
the fastening element (61) including a secondary restricting section (63) and a shank (64) in the form of an extended shaft; the fastening plate (62) being assembled to a winged element (66), which includes an engaging section (65) in the form of a hole; and the shank (64) being pivotally connected to the engaging section (65); and
the linking member (30) being provided between the first end (31) and the second end (32) with a locking hole (36), which is located on around a top of a through hole (38) formed on the linking member (30) to thereby form a raised annular portion (39).

13. The latch device as claimed in claim 1, wherein the actuating lever (20) is provided at the pivotal end (22) with two secondary cantilever arms (25a) and a secondary open area (26a) defined between the two secondary cantilever arms (25a); and the secondary open area (26a) being located adjacent to the shaft receiving section (23); and
the linking member (30) being received in the secondary open area (26a); and the secondary pin holes (27a) being provided at one of two areas, namely, an area on the secondary cantilever arms (25a) located adjacent to a middle area of the actuating lever (20) and an area on the secondary cantilever arms (25a) located adjacent to a lower part of the actuating lever (20), such that the linking member (30) is movable along with the actuating lever (20).

14. The latch device as claimed in claim 2, wherein the actuating lever (20) is provided at the pivotal end (22) with two secondary cantilever arms (25a) and a secondary open area (26a) defined between the two secondary cantilever arms (25a); and the secondary open area (26a) being located adjacent to the shaft receiving section (23); and
the linking member (30) being received in the secondary open area (26a); and the secondary pin holes (27a) being provided at one of two areas, namely, an area on the secondary cantilever arms (25a) located adjacent to a middle area of the actuating lever (20) and an area on the secondary cantilever arms (25a) located adjacent to a lower part of the actuating lever (20), such that the linking member (30) is movable along with the actuating lever (20).

15. The latch device as claimed in claim 13, wherein the actuating lever (20) is provided at an area located adjacent to the shaft receiving section (23) with a slant pressing section (24);
the elastic member (50) being selectively in the form of a torsion spring and including two coiled sections (53) having two opposed ends each, a pair of first projected sections (51) and a pair of second projected sections (52) connected to the opposed ends of the coiled sections (53), and an extended section (54) perpendicularly connected to the two second projected sections (52); and
the shaft bar (73) being assembled to the shaft receiving section (23) of the actuating lever (20), so that the shaft bar (73) extends through the coiled sections (53) of the elastic member (50) and the elongate slots (16) on the shell (10), while the first projected sections (51) of the elastic member (50) are pressed against the pressing section (24) of the actuating lever (20) and the second projected sections (52) and the extend section (54) of the elastic member (50) are pressed against the sliding member (40), such that the actuating lever (20) is movable about the shaft bar (73) and the shaft receiving section (23), and the pivotal end (22) of the actuating lever (20) is allowed to move or rotate in along the elongate slots (16) in a reciprocating motion.

16. The latch device as claimed in claim 14, wherein the actuating lever (20) is provided at an area located adjacent to the shaft receiving section (23) with a slant pressing section (24);
the elastic member (50) being selectively in the form of a torsion spring and including two coiled sections (53) having two opposed ends each, a pair of first projected sections (51) and a pair of second projected sections (52) connected to the opposed ends of the coiled sections (53), and an extended section (54) perpendicularly connected to the two second projected sections (52); and
the shaft bar (73) being assembled to the shaft receiving section (23) of the actuating lever (20), so that the shaft bar (73) extends through the coiled sections (53) of the elastic member (50) and the elongate slots (16) on the shell (10), while the first projected sections (51) of the elastic member (50) are pressed against the pressing section (24) of the actuating lever (20) and the second projected sections (52) and the extend section (54) of the elastic member (50) are pressed against the sliding member (40), such that the actuating lever (20) is movable about the shaft bar (73) and the shaft receiving section (23), and the pivotal end (22) of the actuating lever (20) is allowed to move or rotate in along the elongate slots (16) in a reciprocating motion.

17. The latch device as claimed in claim 13, wherein the linking member (30) is a T-shaped member;
the first end (31) of the linking member (30) being provided with a pair of pin holes (37) and the secondary shaft pin (75) being pivotally connected to the pin holes (37), such that the first end (31) of the linking member (30) is rotatable freely;
the second end (32) of the linking member (30) being provided with a secondary shaft receiving section (33) and the shaft (70) being pivotally connected to the secondary shaft receiving section (33), such that the second end (32) of the linking member (30) is movable freely; and
an area at the second (32) of the linking member (30) located adjacent to the secondary shaft receiving section (33) being provided with a recessed section (34); and the shaft (70) also being pivotally connected to the shaft hole (17) on the shell (10),
the sliding member (40) is in the form of a plate mounted on the shell (10) and is movable freely;
the sliding member (40) being provided between the primary end (43) and the secondary end (44) with an assembling section (41) and a pair of shaft holes (42); the assembling section (41) including two upward protruded plate-like portions and the shaft holes (42) being formed on the assembling section (41); a shaft bar (73) being extended through the shaft receiving section (23) on the actuating lever (20) and the shaft holes (42) on the sliding member (40); and
the shaft bar (73) being pivotally connected to the elongate slots (16), allowing the actuating lever (20) to move from the closed position to the opened position while brings the linking member (30) to move along with the actuating lever (20), such that the shaft bar (73) is movable in along the elongate slots (16) to thereby bring the pivotal end (22) of the actuating lever (20) to move and rotate and also bring the sliding member (40) to move.

18. The latch device as claimed in claim 14, wherein the linking member (30) is a T-shaped member;
the first end (31) of the linking member (30) being provided with a pair of pin holes (37) and the secondary shaft pin (75) being pivotally connected to the pin holes (37), such that the first end (31) of the linking member (30) is rotatable freely;
the second end (32) of the linking member (30) being provided with a secondary shaft receiving section (33) and the shaft (70) being pivotally connected to the secondary shaft receiving section (33), such that the second end (32) of the linking member (30) is movable freely; and
an area at the second (32) of the linking member (30) located adjacent to the secondary shaft receiving section (33) being provided with a recessed section (34); and the shaft (70) also being pivotally connected to the shaft hole (17) on the shell (10),
the sliding member (40) is in the form of a plate mounted on the shell (10) and is movable freely;
the sliding member (40) being provided between the primary end (43) and the secondary end (44) with an assembling section (41) and a pair of shaft holes (42); the assembling section (41) including two upward protruded plate-like portions and the shaft holes (42) being formed on the assembling section (41); a shaft bar (73) being extended through the shaft receiving section (23) on the actuating lever (20) and the shaft holes (42) on the sliding member (40); and
the shaft bar (73) being pivotally connected to the elongate slots (16), allowing the actuating lever (20) to move from the closed position to the opened position while brings the linking member (30) to move along with the actuating lever (20), such that the shaft bar (73) is movable in along the elongate slots (16) to thereby bring the pivotal end (22) of the actuating lever (20) to move and rotate and also bring the sliding member (40) to move.

19. The latch device as claimed in claim 15, wherein the linking member (30) is a T-shaped member;
the first end (31) of the linking member (30) being provided with a pin hole (37) and the secondary shaft pin (75) being pivotally connected to the pin hole (37), such that the first end (31) of the linking member (30) is rotatable freely;
the second end (32) of the linking member (30) being provided with a secondary shaft receiving section (33) and the shaft (70) being pivotally connected to the secondary shaft receiving section (33), such that the second end (32) of the linking member (30) is movable freely; and
an area at the second (2) of the linking member (30) located adjacent to the secondary shaft receiving section (33) being provided with a recessed section (34); and the shaft (70) also being pivotally connected to the shaft hole (17) on the shell (10),
the sliding member (40) is in the form of a plate mounted on the shell (10) and is movable freely;
the sliding member (40) being provided between the primary end (43) and the secondary end (44) with an assembling section (41) and a pair of shaft holes (42); the assembling section (41) including two upward protruded plate-like portions and the shaft holes (42) being formed on the assembling section (41); a shaft bar (73) being extended through the shaft receiving section (23) on the actuating lever (20) and the shaft holes (42) on the sliding member (40); and
the shaft bar (73) being pivotally connected to the elongate slots (16), allowing the actuating lever (20) to move from the closed position to the opened position while brings the linking member (30) to move along with the actuating lever (20), such that the shaft bar (73) is movable in along the elongate slots (16) to thereby bring the pivotal end (22) of the actuating lever (20) to move and rotate and also bring the sliding member (40) to move.

20. The latch device as claimed in claim 16, wherein the linking member (30) is a T-shaped member;
the first end (31) of the linking member (30) being provided with a pin hole (37) and the secondary shaft pin (75) being pivotally connected to the pin hole (37), such that the first end (31) of the linking member (30) is rotatable freely;
the second end (32) of the linking member (30) being provided with a secondary shaft receiving section (33) and the shaft (70) being pivotally connected to the secondary shaft receiving section (33), such that the second end (32) of the linking member (30) is movable freely; and
an area at the second (2) of the linking member (30) located adjacent to the secondary shaft receiving section (33) being provided with a recessed section (34); and the shaft (70) also being pivotally connected to the shaft hole (17) on the shell (10),
the sliding member (40) is in the form of a plate mounted on the shell (10) and is movable freely;
the sliding member (40) being provided between the primary end (43) and the secondary end (44) with an assembling section (41) and a pair of shaft holes (42); the assembling section (41) including two upward protruded plate-like portions and the shaft holes (42) being formed on the assembling section (41); a shaft bar (73) being extended through the shaft receiving section (23) on the actuating lever (20) and the shaft holes (42) on the sliding member (40); and
the shaft bar (73) being pivotally connected to the elongate slots (16), allowing the actuating lever (20) to move from the closed position to the opened position while brings the linking member (30) to move along with the actuating lever (20), such that the shaft bar (73) is movable in along the elongate slots (16) to thereby bring the pivotal end (22) of the actuating lever (20) to move and rotate and also bring the sliding member (40) to move.

21. The latch device as claimed in claim 13, wherein the sliding member (40) is in the form of a plate mounted on the shell (10) and is movable freely;
the sliding member (40) being provided between the primary end (43) and the secondary end (44) with an assembling section (41) and a pair of shaft holes (42); the assembling section (41) including two upward protruded plate-like portions and the shaft holes (42) being formed on the assembling section (41); a shaft bar (73) being extended through the shaft receiving section (23) on the actuating lever (20) and the shaft holes (42) on the sliding member (40); and
the shaft bar (73) being pivotally connected to the elongate slots (16), allowing the actuating lever (20) to move from the closed position to the opened position while brings the linking member (30) to move along with the actuating lever (20), such that the shaft bar (73) is movable in along the elongate slots (16) to thereby bring the pivotal end (22) of the actuating lever (20) to move and rotate and also bring the sliding member (40) to move.

22. The latch device as claimed in claim 14, wherein the sliding member (40) is in the form of a plate mounted on the shell (10) and is movable freely;
the sliding member (40) being provided between the primary end (43) and the secondary end (44) with an assembling section (41) and a pair of shaft holes (42); the assembling section (41) including two upward protruded plate-like portions and the shaft holes (42) being formed on the assembling section (41); a shaft bar (73) being extended through the shaft receiving section (23) on the actuating lever (20) and the shaft holes (42) on the sliding member (40); and
the shaft bar (73) being pivotally connected to the elongate slots (16), allowing the actuating lever (20) to move from the closed position to the opened position while brings the linking member (30) to move along with the actuating lever (20), such that the shaft bar (73) is movable in along the elongate slots (16) to thereby bring the pivotal end (22) of the actuating lever (20) to move and rotate and also bring the sliding member (40) to move.

23. The latch device as claimed in claim 15, wherein the sliding member (40) is in the form of a plate mounted on the shell (10) and is movable freely;
the sliding member (40) being provided between the primary end (43) and the secondary end (44) with an assembling section (41) and a pair of shaft holes (42); the assembling section (41) including two upward protruded plate-like portions and the shaft holes (42) being formed on the assembling section (41); a shaft bar (73) being extended through the shaft receiving section (23) on the actuating lever (20), the shaft holes (42) on the sliding member (40), and the two coiled sections (53) on the elastic member (50); and
the shaft bar (73) being pivotally connected to the elongate slots (16), allowing the actuating lever (20) to move from the closed position to the opened position while brings the linking member (30) to move along with the actuating lever (20), such that the shaft bar (73) is movable in along the elongate slots (16) to thereby bring the pivotal end (22) of the actuating lever (20) to move and rotate and also bring the sliding member (40) to move.

24. The latch device as claimed in claim 16, wherein the sliding member (40) is in the form of a plate mounted on the shell (10) and is movable freely;
the sliding member (40) being provided between the primary end (43) and the secondary end (44) with an assembling section (41) and a pair of shaft holes (42); the assembling section (41) including two upward protruded plate-like portions and the shaft holes (42) being formed on the assembling section (41); a shaft bar (73) being extended through the shaft receiving section (23) on the actuating lever (20) and the shaft hole (42) on the sliding member (40); and
the shaft bar (73) being pivotally connected to the elongate slots (16), allowing the actuating lever (20) to move from the closed position to the opened position while brings the linking member (30) to move along with the actuating lever (20), such that the shaft bar (73) is movable in along the elongate slots (16) to thereby bring the pivotal end (22) of the actuating lever (20) to move and rotate and also bring the sliding member (40) to move.
